(19) United States
(12) Patent Application Publication
(10) Pub. No.: US 2016/0103339 A1
(43) Pub. Date: Apr. 14, 2016

(54) Dual-Sensory Eyewear Device

(71) Applicants: Benjamin L. White, Linden, NJ (US); Russell J. Gulotta, Bohemia, NY (US); Charles Lewis, Linden, NJ (US); Daryl James McCall Evans, Franklin Park, NJ (US)

(72) Inventors: Benjamin L. White, Linden, NJ (US); Russell J. Gulotta, Bohemia, NY (US); Charles Lewis, Linden, NJ (US); Daryl James McCall Evans, Franklin Park, NJ (US)

(21) Appl. No.: 14/974,317

(22) Filed: Dec. 18, 2015

Related U.S. Application Data
(63) Continuation-in-part of application No. PCT/US13/74696, filed on Dec. 12, 2013.
(60) Provisional application No. 61/837,962, filed on Jun. 21, 2013.

(51) Int. Cl. G02C 11/00; G02C 5/02; G02C 5/14; G02C 3/00

(52) U.S. Cl. CPC G02C 11/10; G02C 3/003; G02C 5/02; G02C 5/143

(57) ABSTRACT

A dual-sensory eyewear device for providing visual and aural distractions. The dual-sensory eyewear device includes a frame to which a pair of voltage controlled liquid crystal display lenses and audio devices may be connected. An electronics system and a power system are also included and are housed within the frame. The power system provides electrical current while the electronics package dictates operation of the lenses and the audio devices. Display drivers of the electronics package allow the pair of lenses to switch between an opaque and transparent state, while an audio amplifier operates the pair of speakers. Operation commands to dictate use of the pair of lenses and the pair of speakers can be remotely transmitted to the electronics package through a wireless communication module and interpreted through a signal decoder.

The current application is a Continuation-In-Part of the Patent Cooperation Treaty Application Number PCT/US2013/074696 filed on Dec. 12, 2013, which in turn claims a priority to the U.S. Provisional Patent application Ser. No. 61/837,962 filed Jun. 21, 2013.

### FIELD OF THE INVENTION

The present invention relates generally to a dual sensory distraction simulation eyewear device and associated methods for improving visual and auditory integration (neurological processing) and concentration in the midst of distractions and impeding factors, thereby improving overall psycho-motor reaction time and performance acumen of a user.

### BACKGROUND OF THE INVENTION

Sensory integration (coordination), concentration (focus) and psycho-motor reaction time is an integral aspect of many professions and occupations. For example, athletes must have quick mental and physical reflexes to meet the demands of their chosen profession. Faster reflexes are beneficial in a wide variety of additional professions, further examples of which include military, police, healthcare workers and emergency responders. To address the need for increased sensory integration, mind body control, and more proficient reflexes, a large number of products have been designed and marketed to the aforementioned professionals.

The existing products generally function by blocking a user's sight for preset time increments, limiting the amount of time in which an object is visible and therefore decreasing the amount of time a user has to react to the object. The concept is that users will gradually improve their reflexes to adapt to the reduced time in which an object is visible. Though the concept is sound and backed by scientific research studies, many of these existing solutions suffer from one or more short comings. One issue is the limited adjustment of the time increments; that is, a user might only be able to select from one of a few preset shutter speeds. This discrete approach to shutter speed results in a large difficulty difference between consecutive speed settings, which may slow or otherwise hamper the training of a user. Another issue is the neglect of other senses; though training is often done in a controlled environment, in practice a user might have to deal with multiple distractions, a common example of which is sound. Existing solutions do not address the issue of non-visual distractions. Finally, the interface of many existing solution is limited, often requiring dials and switches to be manipulated to adjust settings. While these interfaces are usable, there remains room for improvement.

It is therefore an object of the present invention to provide a dual-sensory eyewear device for providing visual and auditory distractions with the goal of improving sensory integration (more efficient and proficient processing of sensory stimuli), mental concentration, and physical reflex reaction time. Further objects of the present invention include providing a continuous, rather than discrete, difficulty setting and providing software based training regimens and scenarios.

### BRIEF DESCRIPTION OF THE DRAWINGS

FIG. 1 is an expanded perspective view showing an eyewear frame and an adjustable strap of the present invention.

FIG. 2 is a top plan view showing the eyewear frame of the present invention.

FIG. 3 is a front elevational view showing the eyewear frame of the present invention.

FIG. 4 is right-side elevational view showing the eyewear frame of the present invention.

FIG. 5 is a left-side elevational view showing the eyewear frame of the present invention.

FIG. 6 is a left-side elevational view showing a right half of the eyewear frame of the present invention.

FIG. 7 is a right-side elevational view showing a left half of the eyewear frame of the present invention.

FIG. 8 is a left-side illustration showing a person wearing the present invention.

FIG. 9 is a diagram outlining electrical and electronic connections of the present invention.

FIG. 10 is an illustration showing a voltage-regulating circuit for the present invention.

FIG. 11 is a diagram elaborating upon electrical and electronic connections of the present invention.

### DETAIL DESCRIPTIONS OF THE INVENTION

All illustrations of the drawings are for the purpose of describing selected versions of the present invention and are not intended to limit the scope of the present invention.

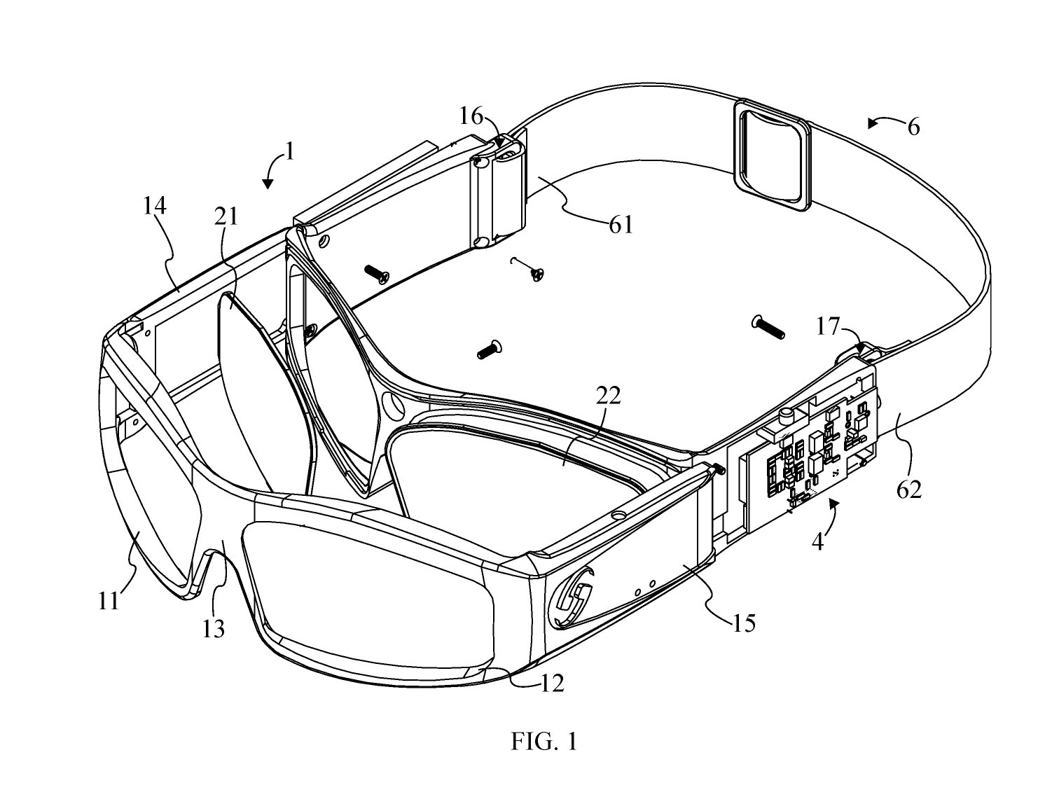

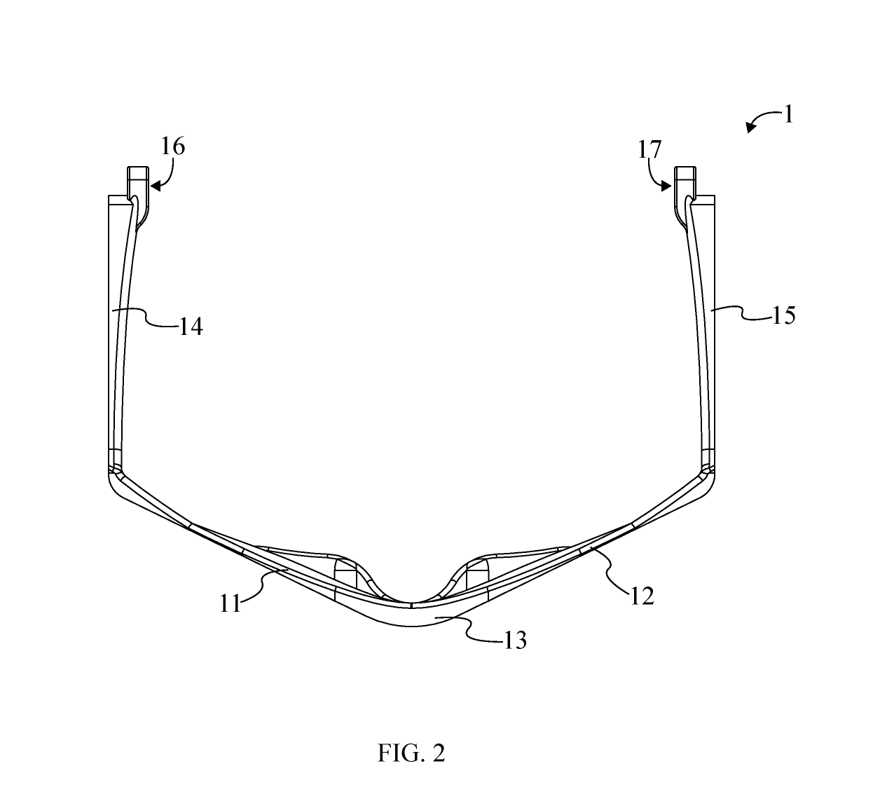

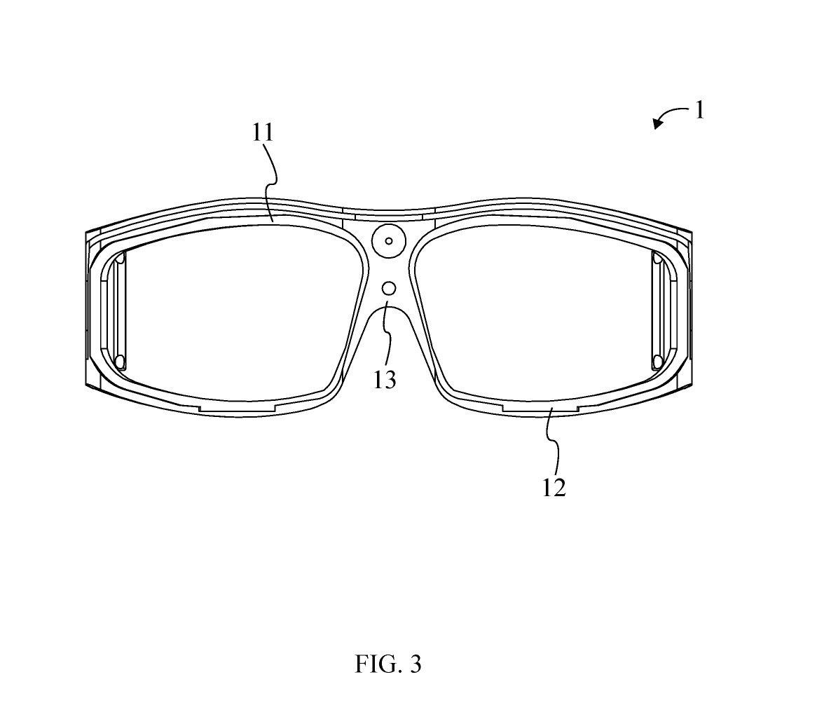

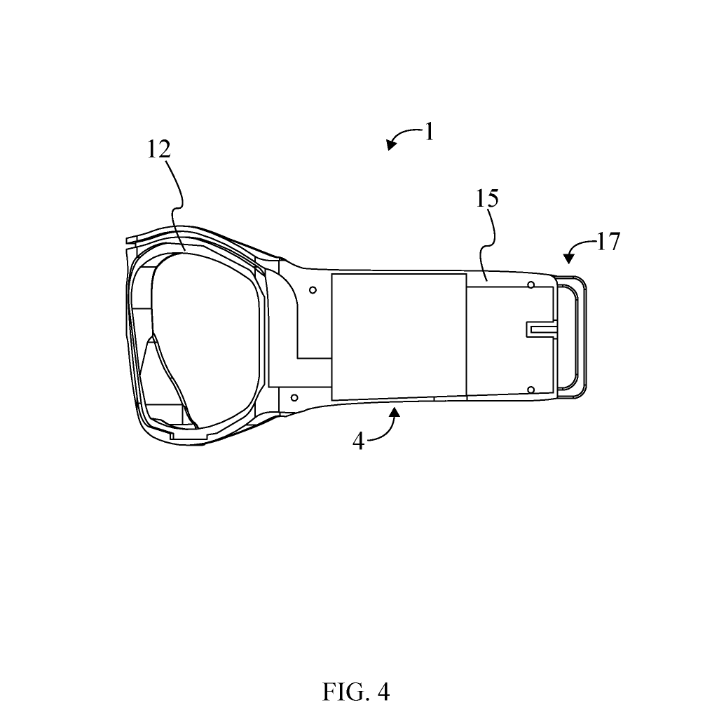

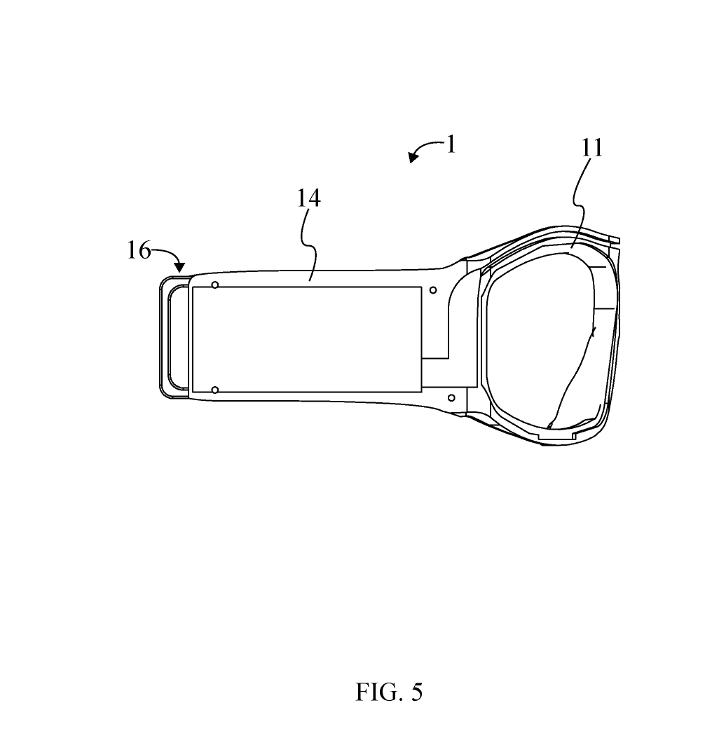

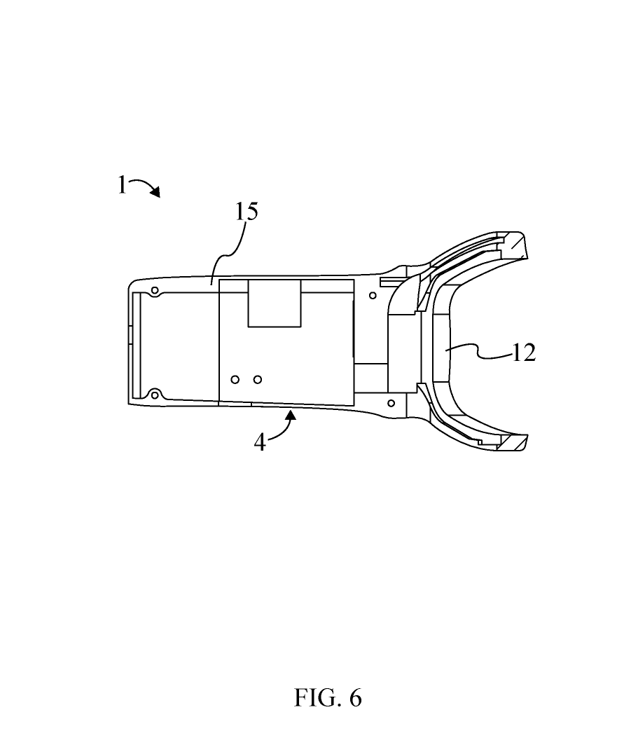

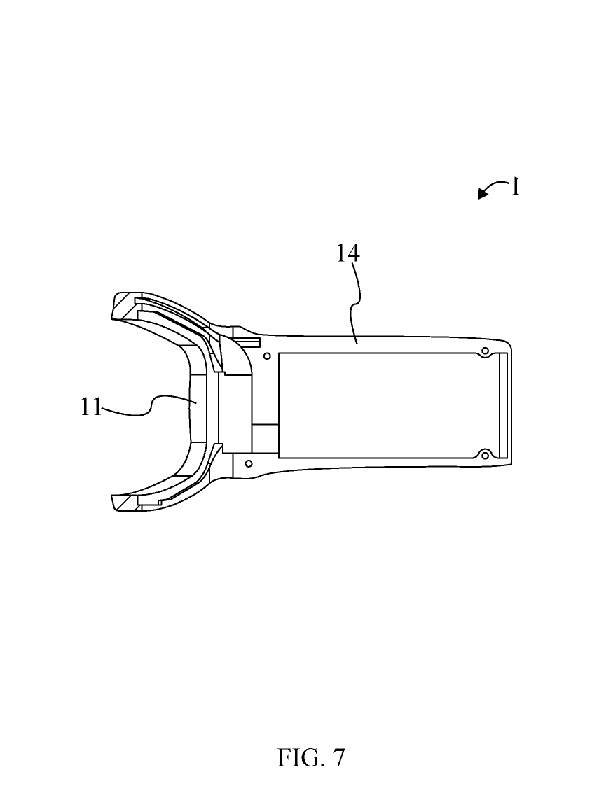

The present invention is a dual-sensory eyewear device, such as shown in FIG. 1-FIG. 8, usable as a sensory integration training device with numerous applications. The eyewear device uses shuttering to transition the lenses between an opaque state and transparent state, thereby producing a stroboscopic effect. This pulsing between opaque and transparent states is used to improve a user's reaction time, with the pulse duration being adjustable to account for changes in user skill. The eyewear device can thus be used to control the amount of time a user is exposed to visual stimuli, resulting in a corresponding decrease in reaction times as the user is trained with the eyewear device.

The eyewear device comprises an eyewear frame 1, a liquid crystal display system 2, an auditory system 3, an electronics system 4, and a power system 5. The eyewear frame 1 allows the present invention to be supported by a user's head, in addition to serving as a mounting point for the other components of the present invention. The liquid crystal display system 2 enables temporary blocking of a user's vision. The auditory system 3 similarly allows for (temporary or continued) generation of distracting noise. The electronics system 4 allows for instructions to be passed to the liquid crystal display system 2 and the auditory system 3, while the power system 5 provides the energy necessary for operation of the present invention.

The liquid crystal display system 2 and the auditory system 3 are both mounted into the eyewear frame 1. The electronics system 4 and power system 5 are housed within the eyewear frame 1, helping to protect them from dust, debris, and other environmental conditions that may result in degradation of said electronics system 4 and power system 5. The electronics system 4 itself comprises a processing unit 41 and a voltage switch 42. The liquid crystal display system 2 is electrically connected with the power system 5 and the voltage switch 42 into a voltage-regulating circuit 43. In another embodiment, voltage control can be integrated into the power system 5 by utilizing a switching power supply. This is a key aspect of the present invention, as the liquid crystal display system 2 can be switched between an opaque state and a transparent state by supplying or cutting voltage flow to the liquid crystal display system 2 from the power system 5. The ability to switch between an opaque state and a visible state allows for a visual strobe effect that is used to help train athletes and other persons to improve their reactions. The power system 5 may comprise a battery, power cord, or ultimately any components that allow for power to be supplied to the electronic components of the present invention.

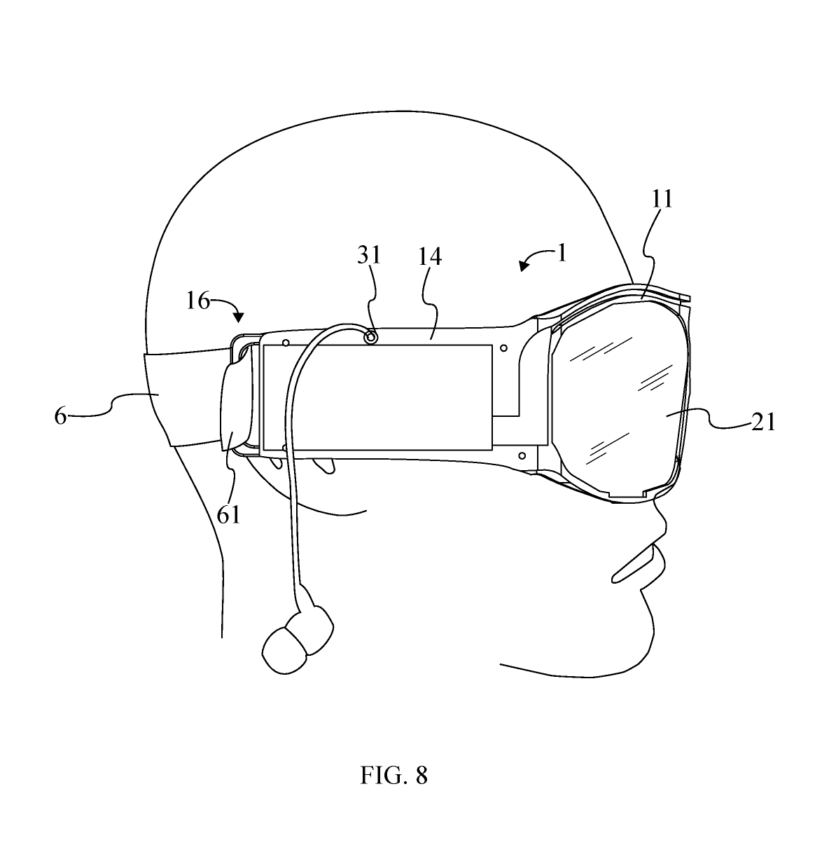

In the preferred embodiment the liquid crystal display system 2 comprises a first liquid crystal display lens 21 and a second liquid crystal display lens 21, one for each eye. Correspondingly, the eyewear frame 1 comprises a first eyewire 11, a second eyewire 12, and a bridge 13. The bridge 13 is connected between the first eyewire 11 and the second eyewire 12, creating a structure capable of receiving the first liquid crystal display lens 21 and the second liquid crystal display lens 21. The first liquid crystal display lens 21 is connected into the first eyewire 11 and the second liquid crystal display lens 21 is connected into the second eyewire 12. More specifically, the edges of each liquid crystal display lens is enclosed by the corresponding eyewire, as illustrated in FIG. 1 and FIG. 8. This setup of the lenses and eyewear frame 1 is based upon normal corrective glasses, with the primary difference being the liquid crystal display property of the lenses, as well as the additional electrical components which are later elaborated upon.

The auditory system 3, one of the aforementioned electrical components, comprises an audio port 31. The audio port 31 allows for a headphone or headphone system to be connected into the present invention, enabling for sound to be played in order to provide aural distractions. To help brace the present invention against the sides of a user's head, the eyewear frame 1 comprises a first temple 14 and a second temple 15. The first temple 14 is adjacently connected to a first eyewire 11 of the eyewear frame 1 and the second temple 15 is adjacently connected to a second eyewire 12 of the eyewear frame 1. The first temple 14 and the second temple 15 are each positioned opposite each other along the first eyewire 11 and the second eyewire 12. As previously described, this configuration mirrors that of traditional sunglasses, with the eyewires being positioned at the front of the user's face and the temples being positioned on either side of the user's head. The audio port 31 is positioned into the eyewear frame 1, allowing for external headphones to be connected to the eyewear frame 1. Multiple audio ports 31 can potentially be provided, with the first temple 14 and the second temple 15 each having one or more integrated audio ports 31. To allow for playback instructions to be passed to a headphone through the audio port 31, the audio port 31 is communicably coupled with the electronics system 4. The two temples also provide a convenient housing for the electronic components of the present invention, as shown in FIG. 1.

In order to secure the present invention about a user's head, a number of implementations are possible. In one embodiment, the temples are of a sufficient length to rest over a user's ears. Thus, in combination with the bridge 13, the present invention is supported by the user's nose and ears. This is similar to how existing sunglasses are worn. Such a configuration is suitable for a number of more sedated training environments, but for more intense training activities it is desirable to have a more secure means of wearing the eyewear device.

Thus, in the preferred embodiment, the present invention comprises an adjustable strap 6 which is placed around the back of a user's head. The adjustable strap 6 comprises a first end 61 and a second end 62. In order to enable an engage with the ends of the adjustable strap 6, the first temple 14 comprises a first strap receptacle 16 while the second temple 15 comprises a second strap receptacle 17. The first strap receptacle 16 is positioned opposite the first eyewire 11 along the first temple 14. Likewise, the second strap receptacle 17 is positioned opposite the second eyewire 12 along the second temple 15. More simply put, the strap receptacles are positioned at the free ends of the temples. As a result, the first end 61 of the adjustable strap 6 is engaged with the first strap receptacle 16, with the second end 62 being engaged with the second strap receptacle 17. The adjustable strap can be expanded or contracted in a number of fashions. The illustrated embodiment shows a buckle which allows for the adjustable strap 6 to be tightened or loosened, but other implementations are possible. For example, a “snap back” (common with baseball caps) could be used for the adjustable strap 6. Further alternatives for the adjustable strap 6 are possible without departing from the scope of the present invention.

To enable the present invention to receive instructions without being hindered by a wired connection, the electronics system 4 further comprises a wireless module 44. The wireless module 44 can communicate with other electronic devices, such as a mobile phone or personal computer, allowing for programs to be loaded that control the frequency and intensity of the distractions created by the liquid crystal display system 2 and the auditory system 3.

The wireless module 44, as with other electronic components, is powered by means of an electrical connection with the power system 5. The wireless module 44 routes received information through the processing unit 41; this is possible thanks to the wireless module 44 being communicably coupled with the processing unit 41. As previously mentioned, this allows instruction files to be received and passed on to the liquid crystal display system 2 and the auditory system 3, enabling a pre-programmed training regimen for improving user reflexes.

Any wireless technology could be implemented with the wireless module 44. For example, in the preferred embodiment, the wireless module 44 is a Bluetooth receiver that can communicate with other Bluetooth enabled devices. Alternatively, wireless networks (commonly referred to as WiFi) could be utilized with the wireless module 44. Potentially, the wireless module 44 could even be supplemented by or replaced with a wired connection, examples of which include Ethernet and Universal Serial Bus (USB) cables. While such wired connections are possible, they will inhibit physical movements and can prove unsafe for certain exercises. Resultantly, the preferred embodiment employees the wireless module 44 over a wired alternative.

The electronics system 4 also comprises a display driver 45 and an audio amplifier 46 which are respectively provided for the liquid crystal display system 2 and the auditory system 3. The display driver 45 is housed within the eyewear frame 1. The processing unit 41 is electrically connected to the second strap receptacle 2 through said display driver 45, allowing for the user's vision to be obstructed when voltage is supplied to the liquid crystal display system 2. Similarly, the audio amplifier 46 is housed within the eyewear frame 1, where it serves as an electrical intermediate between the processing unit 41 and the auditory system 3. That is, the processing unit 41 is electrically connected to the auditory system 3 through the audio amplifier 46. This allows for noise distractions to be created as instructed by a training program.

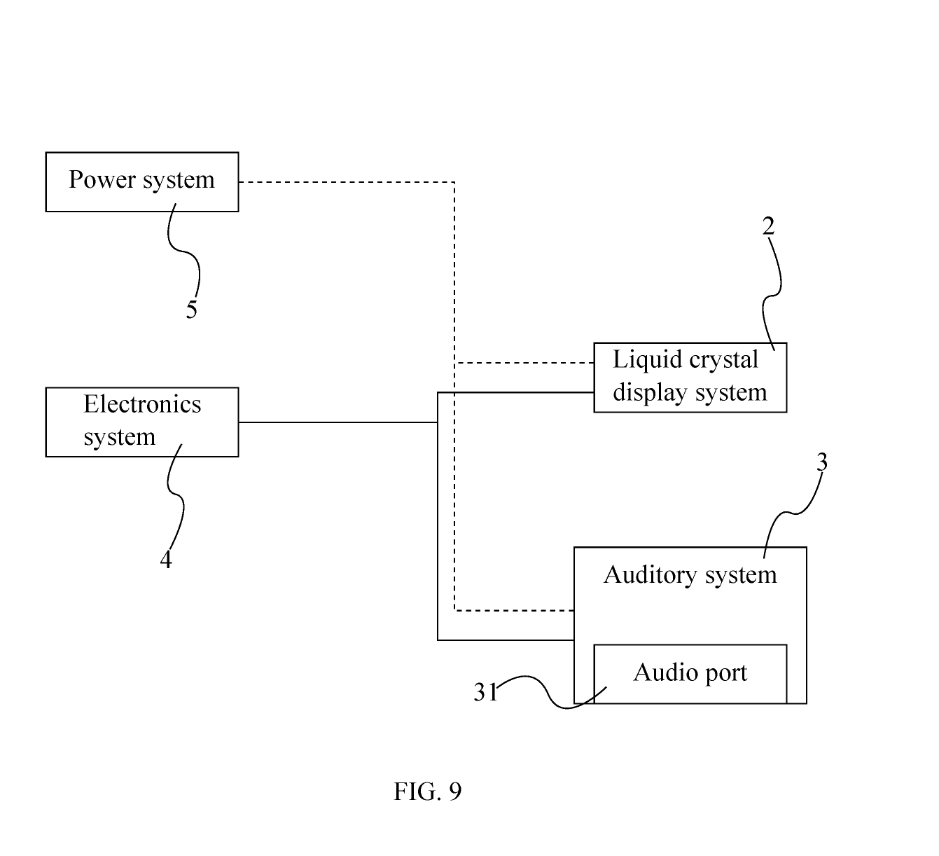

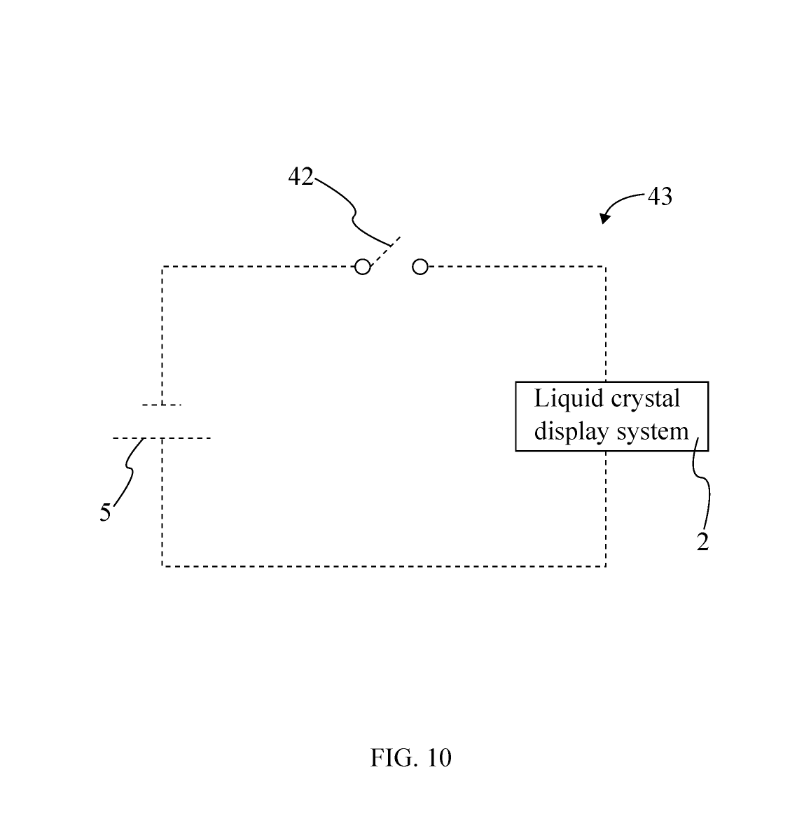

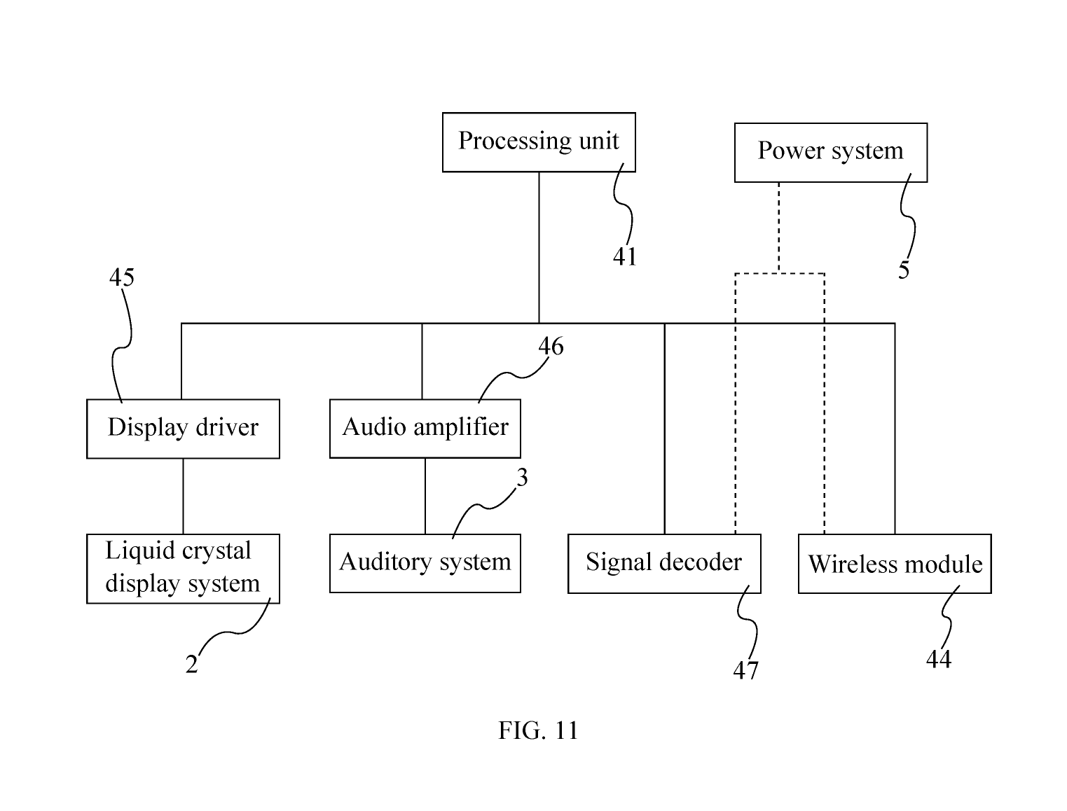

In one embodiment of the present invention, the electronics system 4 further comprises a signal decoder 47. The signal decoder 47 is electrically connected to the processing unit 41, and allows for encrypted files to be read and run by the processing unit 41. This is necessary when proprietary file formats are used with the present invention, the use of proprietary formats being desirable for business purposes. The electronic and electric components of the present invention, as well as their connections, are visualized in FIG. 9-FIG. 11.

The use of proprietary (e.g. encoded) files can allow for several apparatus specific instructions to be implemented with corresponding software for the present invention. Preferably, the proprietary files contain instructions that determine the pulsing of the liquid crystal display lenses, as well as an audio file which is output through the auditory system 3 (i.e. any paired speakers). Also provided in the instructions is an audio range with four channels of information. Four information channels is highly beneficial, as it provides the present invention with variability. For example, an individual channel could be provided for the first liquid crystal display lens 21 and the second liquid crystal display lens 22, as well as for a paired left headphone speaker and right headphone speaker, or even for software drivers in general. Mixing these channels could be used to present a number of combinations, such as utilizing the first lens and the second headphone speaker, or the second lens and the second headphone speaker, or both lenses but neither headphone speaker. These are just a few examples of combinations enabled by the four channel audio range. Another advantage of the present invention is the inclusion of a spectrum of a duty values, allowing for a more continuous adjustment of the shuttering of the lenses. This is an improvement over fixed duty ranges often seen in prior art. These fixed duty ranges, for example, might only provide eight controlled duty cycles. In light of this, the spectrum of duty values provided by the present invention is highly advantageous

A variety of implementations are possible regarding physical assembly of the present invention. The preferred two-piece construction is shown in FIG. 1, where the eyewear frame 1 is divided into an interior portion and an exterior portion, which are connected together to form the full eyewear frame 1. This assembly reduces the number of parts that need to be molded (or otherwise fabricated) for the eyewear frame 1, and further serves to create an enclosed portion in which electronic components may be safely housed. This configuration also allows for the first strap receptacle 16 and second strap receptacle 17 to be integrally formed into the eyewear frame 1, helping to reduce costs and improve production times.

In other embodiments, in which it might be desirable to use hinged temples as with standard sunglasses, the first temple 14 and second temple 15 will have to be manufactured separately from the eyewires and bridge 13. The temples can then be adjacently and hingedly connected to the first eyewire 11 and second eyewire 12, respectively. The hinged connection allows the temples to be folded inwards for a more compact storage configuration, at the expense of a less secure fit compared to the preferred embodiment which utilizes an adjustable strap 6.

In order to use the present invention for training reflexes, a person being trained must don the eyewear frame 1. The proprietary files required for the activation of the liquid crystal display system 2 and the auditory system 3 are then streamed to the device from a source (e.g. a computer, phone, tablet, or similarly capable electronic device) and decrypted by the signal decoder 47. One example of such a proprietary file is an MP11 file. The file, once decrypted, provides settings for the lenses and audio outputs of the eyewear device. The instructions for the lenses indicate the amount of time between transitions from an opaque state to a transparent state, while the audio outputs are provided with a plurality of audio tracks and pulse tones to be played. The instructions also determine the combination of lenses and audio outputs to be used as indicated by the four information channels.

Shuttering of the liquid crystal display system 2 is accomplished by varying voltage, as earlier described. By controlling the supplied voltage, the lenses are switched between opaque and transparent states, effectively limiting the amount of time available to a user for reacting to a visual stimulus. This forces the user to improve their reflexes to accommodate the reduced times for reactions. As a user improves their reaction speed, voltage pulses can be gradually adjusted such that the liquid crystal display system 2 is in an opaque state more frequently than a transparent state. This allows for incremental improvement of the user's reaction time.

The benefits derived from the present invention are desirable in a number of fields and professions. For example, a baseball player may use the present invention to improve their batting. The player would wear the eyewear device during batting practice. The eyewear device would receive an instruction file with a shutter speed appropriate to the batter's current reaction time, as well as an audio track simulating crowd noise. As the batter's reaction time gradually improves, the shutter speed can be adjusted accordingly. In this manner, the player's batting ability improves.

Thanks to the ability to create different software programs for different fields, the present invention has versatile applications. Beyond sports applications, the present invention can be used in the medical profession, in law enforcement, and by the military. These are just a few examples of potential applications and do not preclude use of the present invention in other environments.

Preferably, the proprietary files are factory installed and are designed to prevent unauthorized copying. The proprietary format allows for future expansion as “expansion” instruction files can be sold for download and use with the eyepiece device. These expansion instructions could be designed to train various skill sets (e.g. medical or sports), or to serve as continued training for basic skill sets which were including with the factory installed files.

Although the invention has been explained in relation to its preferred embodiment, it is to be understood that many other possible modifications and variations can be made without departing from the spirit and scope of the invention as hereinafter claimed.

What is claimed is:

1. A dual-sensory eyewear device comprises:
an eyewear frame;
a liquid crystal display system;
an auditory system;
an electronics system;
a power system;
the electronics system being electronically connected to the liquid crystal display system and the auditory system;
the power system being electrically connected to the liquid crystal display system, the auditory system, and the electronics system;
the liquid crystal display system being mounted into the eyewear frame;
the auditory system being mounted into the eyewear frame;
the electronics system being housed within the eyewear frame;
the power system being housed within the eyewear frame;
the electronics system comprises a processing unit and a voltage switch; and
the liquid crystal display system being electrically connected with the power system and the voltage switch into a voltage-regulating circuit.

2. The dual-sensory eyewear device as claimed in claim 1 comprises:
the liquid crystal display system comprises a first liquid crystal display lens and a second liquid crystal display lens;
the eyewear frame comprises a first eyewire, a second eyewire, and a bridge;
the bridge being connected between the first eyewire and the second eyewire;
the first liquid crystal display lens being connected into the first eyewire; and
the second liquid crystal display lens being connected into the second eyewire.

3. The dual-sensory eyewear device as claimed in claim 1 comprises:
the auditory system comprises an audio port;
the eyewear frame comprises a first temple and a second temple;
the first temple being adjacently connected to a first eyewire of the eyewear frame;
the second temple being adjacently connected to a second eyewire of the eyewear frame;
the first temple and the second temple being positioned opposite each other along the first eyewire and the second eyewire;
the audio port being communicably coupled with the electronics system; and
the audio port being positioned into the eyewear frame.

4. The dual-sensory eyewear device as claimed in claim 3 comprises:
an adjustable strap;
the adjustable strap comprises a first end and a second end;
the first temple comprises a first strap receptacle;
the second temple comprises a second strap receptacle;
the first strap receptacle being positioned opposite the first eyewire along the first temple;
the second strap receptacle being positioned opposite the second eyewire along the second temple;
the first end being engaged with the first strap receptacle; and
the second end being engaged with the second strap receptacle.

5. The dual-sensory eyewear device as claimed in claim 1 comprises:
the electronics system further comprises a wireless module;
the power system being electrically connected to the wireless module;
the wireless module being housed within the eyewear frame; and
the wireless module being communicably coupled with the processing unit.

6. The dual-sensory eyewear device as claimed in claim 1 comprises:
the electronics system further comprise a display driver;
the display driver being housed within the eyewear frame; and
the processing unit being electronically connected to the liquid crystal display system through the display driver.

7. The dual-sensory eyewear device as claimed in claim 1 comprises:
the electronics system further comprises an audio amplifier;
the audio amplifier being housed within the eyewear frame; and
the processing unit being electronically connected to the auditory system through the audio amplifier.

8. The dual-sensory eyewear device as claimed in claim 1 comprises:
the electronics system further comprises a signal decoder; and
the signal decoder being electronically connected to the processing unit, wherein the signal decoder decompresses a received data file.

9. A dual-sensory eyewear device comprises:
an eyewear frame;
a liquid crystal display system;
an auditory system;
an electronics system;
a power system;
the electronics system being electronically connected to the liquid crystal display system and the auditory system;
the power system being electrically connected to the liquid crystal display system, the auditory system, and the electronics system;
the eyewear frame comprises a first eyewire, a second eyewire, a bridge, a first temple, and a second temple;
the liquid crystal display system comprises a first liquid crystal display lens and a second liquid crystal display lens;
the auditory system comprises an audio port;
the liquid crystal display system being mounted into the eyewear frame;
the auditory system being mounted into the eyewear frame;
the electronics system being housed within the eyewear frame;
the power system being housed within the eyewear frame;
the electronics system comprises a processing unit, a voltage switch, and a wireless module;
the wireless module being communicably coupled with the processing unit; and
the liquid crystal display lens system electrically connected with the power system and the voltage switch into a voltage-regulating circuit.

10. The dual-sensory eyewear device as claimed in claim 9 comprises:
the bridge being connected between the first eyewire and the second eyewire;
the first liquid crystal display lens being connected into the first eyewire; and
the second liquid crystal display lens being connected into the second eyewire.

11. The dual-sensory eyewear device as claimed in claim 9 comprises:
the first temple being adjacently connected to a first eyewire of the eyewear frame;
the second temple being adjacently connected to a second eyewire of the eyewear frame;
the first temple and the second temple being positioned opposite each other along the first eyewire and the second eyewire;
the audio port being communicably coupled with the electronics system; and
the audio port being positioned into the eyewear frame.

12. The dual-sensory eyewear device as claimed in claim 9 comprises:
an adjustable strap;
the adjustable strap comprises a first end and a second end;
the first temple comprises a first strap receptacle;
the second temple comprises a second strap receptacle;
the first strap receptacle being positioned opposite the first eyewire along the first temple;
the second strap receptacle being positioned opposite the second eyewire along the second temple;
the first end being engaged with the first strap receptacle; and
the second end being engaged with the second strap receptacle.

13. The dual-sensory eyewear device as claimed in claim 9 comprises:
the power system being electrically connected to the wireless module; and
the wireless module being housed within the eyewear frame.

14. The dual-sensory eyewear device as claimed in claim 9 comprises:
the electronics system further comprise a display driver;
the display driver being housed within the eyewear frame; and
the processing unit being electronically connected to the liquid crystal display system through the display driver.

15. The dual-sensory eyewear device as claimed in claim 9 comprises:
the electronics system further comprises an audio amplifier;
the audio amplifier being housed within the eyewear frame; and
the processing unit being electronically connected to the auditory system through the audio amplifier.

16. The dual-sensory eyewear device as claimed in claim 9 comprises:
the electronics system further comprises a signal decoder; and
the signal decoder being electronically connected to the processing unit, wherein the signal decoder decompresses a received data file.
